(19) United States
(12) Patent Application Publication
(10) Pub. No.: US 2025/0109827 A1
(43) Pub. Date: Apr. 3, 2025

(54) Pressure Vessel Nozzle and Associated Method

(71) Applicant: Air Products and Chemicals, Inc., Allentown, PA (US)

(72) Inventors: Gordon Jonas, Schwenksville, PA (US); Robert Francis Heisler, JR., Whitehall, PA (US); Micah S. Kiffer, Kutztown, PA (US); Roger D. Whitley, Allentown, PA (US)

(73) Assignee: Air Products and Chemicals, Inc., Allentown, PA (US)

(21) Appl. No.: 18/739,953

(22) Filed: Jun. 11, 2024

Related U.S. Application Data
(60) Provisional application No. 63/586,081, filed on Sep. 28, 2023.

(51) Int. Cl. F17C 13/04; B01D 53/047; F17C 1/00

(52) U.S. Cl. CPC F17C 13/04; B01D 53/047; F17C 1/00; B01D 2256/16; B01D 2257/504

(57) ABSTRACT

A nozzle for a pressure vessel can include a lip design that facilitates an improved reduction in stress at a location at which the nozzle can be joined to the vessel. Embodiments can include a contoured annular lip element for attachment to an end of a vessel to position a nozzle within an opening at an end of the vessel for fluidly connecting the vessel to another plant element. The nozzle can include one or more geometries to position a weld for joining the nozzle to the end of the vessel so that the weld is located at a pre-selected location to experience a pre-selected level of stress during operation of the vessel to facilitate use of a vessel having a reduced overall wall thickness to provide a vessel having an overall lower weight and capital cost while also improving the ease with which maintenance can be performed.

### CROSS-REFERENCE TO RELATED APPLICATIONS

The present application claims priority to U.S. Provisional Patent Application No. 63/586,081, which was filed on Sep. 28, 2023.

### FIELD OF THE INVENTION

The present innovation relates to nozzles for vessels (e.g. nozzles for vessels used in pressure swing adsorption systems, etc.), apparatuses that can utilize one or more vessels having one or more of the nozzles, and processes of making and using such nozzles, vessels, and apparatuses.

### BACKGROUND OF THE INVENTION

Pressure vessels are generally designed to a published code, such as ASME, EN 13445, PD5500, GB and others. These codes typically dictate the thicknesses required for various components under certain design conditions. For pressure equipment operating with cyclic stresses, the thickness can be dictated by fatigue or static pressure. The thickness for vessel component(s) required for a static pressure can be calculated using code methods and the vessel maximum allowable working pressure (MAWP), and the thickness required for fatigue can be calculated using fatigue allowable stresses, the operating stress range and number of cycles. In processes such as Pressure Swing Adsorption (PSA) processes, cyclic pressure can be a major source of cyclic stresses acting on the vessels of the PSA. Examples of PSA systems and/or PSA processing can be appreciated from U.S. Pat. Nos. 7,390,350, 7,404,846, 7,491,260, 7,651,549, 7,717,981, 8,016,918, 8,529,674, 8,778,051, 9,101,872, 9,381,460, 10,730,006, 10,744,450, and 10,835,856.

### SUMMARY OF THE INVENTION

We have determined that, in cases of large pressure swings, relative to the MAWP, and a high number of cycles, thicknesses of components of a vessel (e.g. vessel wall, thickness of the wall for the head of the vessel, thickness for the nozzle of the vessel, etc.) can be dictated by the cyclic stresses. In other words, the applicable standards can often result in vessels being designed to be thicker to account for the cyclic pressure and related stresses that are experienced by that equipment.

For pressure vessels in fatigue service, a peak stress can be calculated to help ensure that the peak stress is adequate for the vessel's operating conditions. A nozzle design for a vessel in fatigue service may need to have a different structure than a nozzle used in a pressure vessel in static service to account for the different stress and peak stress conditions that can arise due to the cyclical operational conditions for vessels used in cyclical pressuring processing to account for the cyclical stresses and fatigue that can be experienced by vessels in such operational situations. In many cases, we have determined that the stress increase in nozzle locations can surprisingly dictate the thickness of other vessel components, such as the shell and heads.

Pressure vessel codes, such as ASME codes, often have requirements dictating the allowable stress for welded and non-welded (or base) metals. Generally, good quality butt-welds have a fatigue allowable stress less than non-welded material. The ratio of the allowable stress for non-welded metal compared to a good quality butt-weld is generally in the range of 1.2 to 1.4. The term, “Fatigue strength reduction factor,” or FSRF, is often used to describe the ratio of allowable stress of base metal to a welded joint. The higher allowable stress means that non-welded material can have a higher stress than welded joint. When designing pressure vessels components and trying to minimize costs, we have found that it can be advantageous to locate welds in areas of lower stress to help minimize the required thickness of vessel components.

It is also possible that the fluid operating inside the vessel may have a negative impact on the design life of a vessel. For example, hydrogen is known to enhanced fatigue crack growth rates in pressure vessel carbon steels. An environmental strength reduction factor can be used to account for the effects of an operating fluid that will negatively impact the fatigue life, which may be calculated using the ratio of allowable stress in air service divided by the allowable stress in the environment. If an environmental strength reduction factor is used in the design of a vessel in cyclic service, the allowable stress on the inner surface of the vessel can be lower than the allowable stress in the interior of the metal and on the outer surface. Conventionally, accounting for the decreased fatigue performance in hydrogen service often results in thicker components. However, embodiments we have developed can avoid use of thicker, heavier structures that can permit different components to be provided at lower weights and costs.

For example, typical PSA adsorber vessels are designed with a cylindrical shell and a 2:1 ellipsoidal head on each end, with the adsorbent material of the vessel located inside the vessel (e.g. adsorbent material can be in one or more layers within a bed of adsorbent material positioned within the cavity of the vessel). A nozzle can often be located in the center of each ellipsoidal head for an inlet that can receive feed gas on one end, and an outlet to provide product gas on the other end. Typically, the nozzles are conventionally designed to mate with the sizing of the vessel to which the nozzle is to be attached and to minimize the cost of the nozzle.

However, we have surprisingly found that these nozzles are often areas of high stress. This is particularly true for vessels used in applications in which cyclical pressure is to be experienced by the vessel (e.g. vessels of a PSA system). We have found that the stress concentration around the nozzle can be high enough so the head thickness is required to be increased to reduce the stress concentration to an acceptable level. we have surprisingly found that the geometry of the nozzle can be modified to minimize the stress concentration factor that can also permit the sizing of the vessel to be modified so that the vessel can be a lower weight vessel with thinner walls that define the vessel inner chamber while the nozzles can be sized and structured to be thicker and more robust (e.g. more expensive) to account for the higher stress conditions for providing inlet and outlet openings to the vessel's chamber. We have surprisingly found that such an approach, while using higher cost nozzles, can provide a robust design that provides great flexibility in use, is able to better withstand stresses (e.g. provide reduced need of maintenance), facilitate improved maintenance operations for periodically checking on the integrity of the vessels in use, while also providing an overall reduced capital cost for the vessel and system of vessels due to reducing a thickness requirement for the vessel wall(s) that define the vessel's chamber that can be surprisingly provided by use of a more robust, higher cost nozzle configuration.

Typical hydrogen PSA adsorber vessels can have the following dimensions for a number of applications:
Vessel Shell Diameter between 4 ft and 12 ft, or 1.21 meters (m) to 3.66 m;
Vessel Shell and head thicknesses between 1 inch and 5 inches, or 2.54 centimeters (cm) to 12.7 cm;
Nozzle diameters between 4 inches and 24 inches, or 10.1 cm to 61 cm.

Buffer tanks can have the following attributes:
Vessel shell diameters ranging between 4 ft (1.21 m) and greater than 20 ft (6.1 m);
Vessel thicknesses ranging between 0.5 inches (1.27 cm) and 3 inches (7.62 cm);
Configuration for containing hydrogen gas, gas with hydrogen, and fluid without hydrogen.

For a hydrogen PSA vessel, the stress concentration factor in a 2:1 elliptical head vessel configuration is typically around 1.6, and the maximum stress can be located on the inside surface of the knuckle of the head. To minimize the thickness of the pressure vessel head, we have found that it is beneficial to design the nozzle to have a stress concentration factor equal to, or less than the stress concentration factor of the head. Additionally, because the weld has a lower allowable stress than the base metal, preferably the weld for joining the nozzle to the vessel structure can be located at an area of low stress because the weld will not govern the thickness of the head if the stress at the weld multiplied by the FSRF is less than the maximum stress in the head and nozzle.

We have found that contoured lip forgings for nozzle designs can be utilized in conjunction with pressure vessels to provide advantages compared to other pressure vessel nozzle details. For example, for vessels in cyclic pressure service, some advantages we have found can include more easily inspectable welds, and smooth transitions radii which can minimize stress concentrations.

To evaluate our belief that a higher cost, more robust nozzle design may be utilized to help provide an overall lower cost, lightweight vessel usable for cyclical pressure applications (e.g. a PSA application), we performed extensive finite element analyses to cover a wide range of typical vessel sizes (as stated above). During these analyses we identified different geometric ratios that can be utilized to provide an improved nozzle design that can also provide a substantial reduction in stress experienced by the nozzle while also permitting the overall vessel design having the nozzle(s) to be substantially lighter in weight and be, overall, less in cost to make and use while also facilitating improved maintenance and safety that can result from the improved maintenance operations. These geometric ratios for the nozzle we have identified on a basis of a thickness t of a wall of the vessel body or thickness of the wall of the head of the vessel to which the nozzle is to be attached via welding include:
Dimension 1—a lip design for the nozzle for attachment to the body of the vessel adjacent an end of the vessel in which the weld for attachment of the nozzle to the body is located at a distance that is between 0.75t and 4t (e.g. 1t-4t, 1.5t-4t, 1t-2.5t, 1.5t-2.5t, etc.) to a proximate end of the lip of the nozzle.
Dimension 2—an inner curved transition between the proximate end of the lip of the nozzle and the inner wall segment of a barrel of the nozzle defining the fluid pathway through the opening of the nozzle in which the inner curved transition segment is a curved segment (e.g. a radial segment) that extends a distance along a radius of between 0.5t and 2t (e.g. 0.8t-1.2t, 0.6t-1.4t, etc.).
Dimension 3—an outer curved transition between the proximate end of the lip and the outer surface of the barrel of the nozzle that can extend along a curved length of between 0.5t and 3t (e.g. 1.5t to 1t, 0.75t to 2t, etc.). For example, the outer curved transition can be a radial segment that extends along such a length or distance.
Dimension 4—the vessel interface side of the nozzle having an interior surface for facing the chamber of the vessel that is sized to match or substantially match (e.g. being 0.8-1.1 or being 0.9 to 1.0 of a match) for the curvature of the head of the vessel removed from the vessel for defining the hole in which the nozzle is positionable for attachment to the head of the vessel.
Dimension 5—the barrel thickness for the nozzle being between 0.5t and 3t (e.g. 1.5t−1t, 1.2t−2.5t, 1t−2t, etc.) for the portion of the barrel that extends from a location adjacent a vessel interface opening to an intermediate location of the fluid pathway that is between this interface opening and a second end interface opening that is opposite the vessel interface opening. In some situations, the barrel may taper from this intermediate location to the second end interface opening as well.
Dimension 6—the barrel length defining the fluid pathway length between the vessel interface opening of the nozzle adjacent the inner chamber of the vessel to the intermediate portion of the barrel such that a length of the barrel is between 0.5t and 6t (e.g. 0.5t-5t, 1t-5t, 1.5t-4t, etc.). This length can be the length of the barrel from the outer curved transition to the intermediate portion of the barrel that is between the vessel interface opening of the nozzle and the second end interface opening of the nozzle that is opposite the vessel interface opening of the nozzle.
Dimension 7—a lip and barrel configuration in which a distance between the inner diameter of the nozzle passageway and the weld that is to be integral to the distal edge of the lip of the nozzle for attachment of the nozzle to a vessel wall is greater than 2t (e.g. is between 2t and 8t, is 2.5t-7t, is 2.5t-6.5t, is 2t-5t, 3t-6t, 4t-6t etc.).

The above noted nozzle dimensions can be particularly useful for larger vessels (e.g. vessels that have internal diameters greater than 6 feet, or 1.83 m).

We have found that utilization of one or more of these geometries of Dimensions 1-7 (e.g. just Dimension 1, a combination of two or more of Dimensions 1-7, a combination of three or more of the Dimensions 1-7, a combination of four or more of the Dimensions 1-7, a combination of five or more of the Dimensions 1-7, a combination of six or more of the Dimensions 1-7, combination of all of the Dimensions 1-7, only one of Dimensions 1-7, etc.) can provide a nozzle design that is substantially different from conventional designs and that can also provide surprising advantages in reducing the thickness (e.g. the thickness of the vessel sidewall) for a vessel that can result in a more cost-effective pressure vessel that is also lighter weight and can also accommodate easier and more accurate testing to facilitate improved maintenance operations and safety improvements that can be provided via such improved maintenance operations.

For example, we have found that providing a nozzle design that facilitates use of a weld for joining the nozzle to an end of a vessel that is located a distance from the inlet of the nozzle that is between 4 times and 0.75 times the thickness of the sidewall of the head of the vessel (a portion of which can be cut away from the vessel to define the opening of the vessel in which the nozzle is positionable) can position the nozzle so that the weld used to join the nozzle to the body of the vessel is exposed to substantially lower stresses in use. A conventional view of this type of design would be the fact that a larger size of a head of a vessel must be removed to accommodate such a nozzle assembly, and this would increase the waste and cost associated with the vessel design. However, this larger sized opening and cost of waste has been found to ultimately result in a lower weight and lower cost overall vessel design due to the stress reductions at the weld that can be provided. We believe this is a surprising and counterintuitive finding based on how nozzle and vessels are conventionally designed and the conventional design considerations utilized in designing vessels and nozzles for vessels used in cyclical pressure applications (e.g. PSA applications).

It is also contemplated that other embodiments of a nozzle can facilitate use of a weld for joining the nozzle to an end of a vessel that is located a distance from the inlet of the nozzle that is greater than 4 times the thickness of the sidewall of the head of the vessel. While such embodiments can be utilized, we have surprisingly found that often such a larger distance is not needed to obtain improvements in reduced overall vessel weight and cost while also obtaining desired stress reductions.

For larger vessels, we have found that a nozzle design that facilitates use of a weld for joining the nozzle to an end of a vessel that is located a distance from the inlet of the nozzle that is greater than 4 times the thickness of the sidewall of the head of the vessel can be beneficial for vessels of larger sizes. As the cost of the vessel increases with its size, we have surprisingly found that the removal of a portion of the vessel for nozzle attachment can incur a smaller percentage of cost that can also result in a higher overall cost savings for fabrication, weight, and maintenance by utilization of an embodiment of our nozzle, which may be a more expensive component (e.g. the costs associated with design and fabrication of custom forgings for a nozzle can be more beneficial the larger the vessel). We have found that this can be beneficial for larger sized vessels having a diameter of at least 4 feet (1.2 m) and that this benefit is even more pronounced in conjunction with vessel sizes greater than 6 feet (1.83 m) in diameter.

As another example, use of larger shaped radial elements in nozzle designs can provide significantly larger nozzle elements that we have found to facilitate improved nozzle robustness while also accommodating thinner vessel wall structures that can facilitate a higher cost nozzle design that can surprisingly facilitate use of lower weight vessels that can have an overall lower cost in spite of the nozzle component being larger and of higher cost.

As yet another example, the width and length of a defined conduit for the nozzle body can be pre-selected to further enhance the stress reductions and robustness of the nozzle design to accommodate thinner walled vessels. Some embodiments may utilize only one of such features while others may utilize a combination of such features (e.g. all of such features, two or more of such features, etc.) as noted above and elsewhere herein.

We have found that the stresses at a nozzle are generally higher close to the nozzle to vessel head junction and decrease as the distance away from the discontinuity at this junction increases. Embodiments of the nozzle can be provided so that the distance between the weld used to connect the nozzle to the vessel and the radius of the nozzle is sized so that the stress at the weld is reduced to less than the inverse of the FSRF compared to the maximum stress. It was found that, among the range of typical PSA dimension vessels, that approximately 2 times the thickness of the head can be optimal in some embodiments (e.g. between 0.75 times this thickness to 4 times this thickness, etc.). The weld being further away from the nozzle adds cost by making the body of the nozzle larger (e.g. the size of the forged nozzle body can be significantly larger). However, we have surprisingly found that this higher cost nozzle is more than offset by the reduction in wall thickness of the vessel head(s) and overall weight of the vessel that can be provided by use of the nozzle(s), which can reduce the overall cost for the vessel and also reduce the overall weight of the vessel having the nozzle(s) substantially.

Additionally an embodiment of the nozzle can be incorporated into the shell of the pressure vessel. Similar to the stress concentration at the weld of the nozzle in a head, the stress concentration at the weld of a nozzle in a shell can be reduced by increasing the distance between the weld joint that connects the nozzle to the vessel wall of the shell and the center of the nozzle (or inner sidewall defining the passageway for fluid in a barrel of the nozzle).

We have also found that embodiments in which the weld can be located a distance that is approximately 2 times or greater the thickness of the wall of a head of the vessel away from the inner fluid pathway of the nozzle and/or proximate end of the lip of the nozzle can also offer advantages for the inspection and maintenance of the vessel. For instance, we have found that such sizing can facilitate improved use of ultrasonic inspection of the weld, allowing a more comprehensible inspection of the nozzle from the outside surface of the vessel. This improvement can include improved ability to adjust a probe through the nozzle and inside the vessel body to evaluate the weld, for example. In some configurations, this type of facilitation can be provided by sizing of the fluid passageway and the distance between the weld and the inner passageway of the nozzle through which fluid can pass being greater than two inches, or greater than five centimeters. This type of improvement can allow maintenance to occur more quickly and also provide a more reliable result that can facilitate reduced downtime for maintenance while also providing an improvement in operation and safety by more proactively and accurately detecting structural issues that may require repair or replacement.

We have surprisingly found that there can be a general shortcoming with most code-based methods to calculate stress at a nozzle is there is typically (if not always) no attempt to calculate the stress at the weld separately from the base metal of the vessel. As the stress in the weld can be much less than the maximum stress, we surprisingly found and that this can be an important factor for facilitating vessel design that may have a substantially reduced overall thickness of pressure vessel components even though a nozzle may ultimately be bigger and more expensive for such a vessel.

Embodiments of the nozzle, vessel and apparatus can provide a surprising and unexpected number of benefits. For instance, many methods for calculating stress do not consider where the weld is located, and therefore, do not have guidelines on where to locate the weld. We have, however, surprisingly found that such design criteria can have a significant impact on the vessel and nozzle designs, their cost of manufacture, the flexibility of their use and transport, and their ease of maintenance. For example, embodiments of the nozzle can be sized and configured to account for this design criteria while also providing other unexpected benefits (e.g. facilitate improved maintenance by accommodating improved positional flexibility of a probe within the vessel to monitor the structural integrity of the vessel and/or nozzle, facilitate a vessel design using thinner vessel wall to provide a vessel with an overall lower weight, etc.).

Embodiments of a PSA system can be provided that can utilize multiple vessels having embodiments of the nozzle attached thereto. Some embodiments can utilize more than 2 vessels, between 2 vessels and 12 vessels, or other number of vessels for cyclical pressurization of the vessels for adsorption operations, for example. Embodiments of such a PSA system can be provided with a substantially lower capital cost that also provides a significant reduction in weight of the overall system as well as a more reliable and easier to perform set of maintenance operations (which can result in improved safety in operations and use of the vessel(s)).

In a first aspect, a nozzle for a pressure vessel that is sized for being welded to a wall of the vessel can be provided. The nozzle can include a barrel attached to an annular lip. The barrel can define an inner passageway that is in fluid communication with a vessel interface opening defined by the lip at a first end of the nozzle. The second end of the nozzle can be opposite the first end of the nozzle. The second end of the nozzle can have an interface opening in communication with the inner passageway. The lip can have a distal side that is opposite a proximate side. The proximate side of the lip can be positionable around an inner end of the barrel to define the vessel interface opening. The proximate side of the lip can be spaced apart from the distal side of the lip by a first distance that is between 4 times a thickness of the wall (t) and 0.75t such that a joint of the weld between the wall and the distal side of the lip is a distance of between 4t and 0.75t from the proximate side of the lip.

The nozzle can be configured to facilitate a fluid connection of a vessel to a source of fluid or a conduit through which fluid is passable for feeding into the vessel or for outputting of fluid from the vessel to a downstream element. Embodiments of the nozzle can also include other features as well.

In a second aspect, the nozzle can have an inner curved transition that is positioned to extend between the proximate side of the lip and the inner passageway of the barrel. The inner curved transition can extend a distance of between 0.5t and 2t. The inner curved transition can be on an inner side of the nozzle that is opposite an outer side of the nozzle.

In a third aspect, the nozzle can have an outer curved transition that is positioned to extend between the proximate side of the lip and the barrel. The outer curved transition can extend a distance that is between 0.5t and 3t. The outer curved transition can be on an outer side of the nozzle that is opposite an inner side of the nozzle.

In a fourth aspect, an annular wall of the barrel can define the inner passageway. There can be a thickness at an intermediate portion of the barrel that is located between the vessel interface opening and the interface opening of the second end of the nozzle. The thickness at the intermediate portion of the barrel can be between 0.5t and 3t. In some embodiments, an outer surface of the barrel can extend from the outer curved transition to the intermediate portion of the barrel by a distance that is between 0.5t and 6t. The barrel can taper from the intermediate portion to the interface opening of the second end of the nozzle in some embodiments. Other embodiments may not be so tapered.

In a fifth aspect, the lip can be contoured to substantially match a contour of a portion of a head of the end of the vessel that was removed to form a hole in which the nozzle is positionable. In other embodiments, the lip can be contoured to substantially match or exactly match a contour of a portion of the vessel wall that was removed to form a hole in which the nozzle is positionable. In some embodiments, the hole can be formed in an intermediate tubular body of the vessel or the hole can be formed in a wall that is a portion of a formed head end of the vessel.

In a sixth aspect, the proximate side of the lip can be spaced apart from an inner surface of the barrel defining the inner passageway at the first end of the nozzle by a distance that is between 2t and 6t such that a joint of the weld between the wall and the distal side of the lip is a distance of between 2t and 6t from the inner surface of the barrel defining the inner passageway at the first end of the nozzle.

In a seventh aspect, the first distance can be at least 2.5 cm (e.g. between 2.5 cm and 10 cm, between 2.5 cm and 20 cm, between 2.5 cm and 30 cm, etc.). In some embodiments, the wall of the vessel can be a wall of a vessel head having a thickness of at least 2.5 cm (e.g. t is 2.5 cm or is at least 2.5 cm).

In an eight aspect, the nozzle of the first aspect can include other features. For example, the nozzle of the first aspect can include one or more of the features of the second aspect, third aspect, fourth aspect, fifth aspect, sixth aspect and/or seventh aspect. The nozzle can also include other features (e.g. be forged from a metal or an alloy, etc.). Embodiments can also utilize other features or elements. Examples of such features or elements can be appreciated from the exemplary embodiments of the nozzle discussed herein.

In a ninth aspect, a vessel for an apparatus can be provided. The vessel for the apparatus can be configured to utilize cyclic pressurization. Embodiments of the vessel can include a body having a first end and a second end. The first end of the body of the vessel can have an opening defined therein and the first end can also have a wall. The body of the vessel can also define a chamber within the vessel. The vessel can also include a first nozzle positioned within the opening defined in the first end of the body. The first nozzle can include a barrel attached to an annular lip. The barrel can define an inner passageway that is in fluid communication with a vessel interface opening defined by the lip at a first end of the first nozzle. A second end of the first nozzle that is opposite the first end of the first nozzle can have an interface opening in communication with the inner passageway. The lip can have a distal side that is opposite a proximate side. The proximate side can be positionable around an inner end of the barrel to define the vessel interface opening. The proximate side of the lip can be spaced apart from the distal side of the lip by a first distance that is between 4 times a thickness of the wall (t) and 0.75t such that a joint of a weld between the wall and the distal side of the lip is a distance of between 4t and 0.75t from the proximate side of the lip.

In a tenth aspect, the second end of the body of the vessel can have an opening defined therein. The second end of the body of the vessel can also have a wall. The vessel can also include a second nozzle positioned within the opening defined in the second end of the body of the vessel. The second nozzle can include a barrel attached to an annular lip. The barrel of the second nozzle can define an inner passageway that is in fluid communication with a vessel interface opening defined by the lip of the second nozzle at a first end of the second nozzle. A second end of the second nozzle opposite the first end of the second nozzle can have an interface opening in communication with the inner passageway of the barrel of the second nozzle. The lip of the second nozzle can have a distal side that is opposite a proximate side. The proximate side of the lip of the second nozzle can be positionable around an inner end of the barrel of the second nozzle to define the vessel interface opening of the second nozzle. The proximate side of the lip of the second nozzle can be spaced apart from the distal side of the lip of the second nozzle by a distance that is between 4 times a thickness of the wall of the second end (t′) and 0.75t′ such that a joint of a weld between the wall of the second end and the distal side of the lip of the second nozzle is a distance of between 4t′ and 0.75t′ from the proximate side of the lip of the second nozzle.

In an eleventh aspect, the vessel can be provided so that the first nozzle has an inner curved transition that is positioned to extend between the proximate side of the lip and the inner passageway of the barrel, the inner curved transition extending a distance of between 0.5t and 2t. In embodiments that utilize a second nozzle, the second nozzle can also have an inner curved transition that is positioned to extend between the proximate side of the lip of the second nozzle and the inner passageway of the barrel of the second nozzle wherein the inner curved transition of the second nozzle extends a distance of between 0.5t′ and 2t′.

In a twelfth aspect, the vessel can be provided so that the first nozzle has an outer curved transition that is positioned to extend between the proximate side of the lip and the barrel wherein the outer curved transition extends a distance that is between 0.5t and 3t. In embodiments that also utilize a second nozzle, the second nozzle can also have an outer curved transition that is positioned to extend between the proximate side of the lip and the barrel of the second nozzle wherein the outer curved transition of the second nozzle extends a distance that is between 0.5t′ and 3t′.

In a thirteenth aspect, an annular wall of the barrel of the first nozzle that can define the inner passageway has a thickness at an intermediate portion of the barrel that is located between the vessel interface opening and the interface opening of the second end of the first nozzle. The thickness at the intermediate portion of the barrel of the first nozzle can be between 0.5t and 3t. For embodiments of the vessel that utilize a second nozzle, an annular wall of the barrel of the second nozzle that can define the inner passageway of the second nozzle can have a thickness at an intermediate portion of the barrel that is located between the vessel interface opening and the interface opening of the second end of the second nozzle. The thickness at the intermediate portion of the barrel of the second nozzle can be between 0.5t′ and 3t′.

In a fourteenth aspect, an outer surface of the barrel of the first nozzle can extend from the outer curved transition of the first nozzle to the intermediate portion of the barrel of the first nozzle at a distance that is between 0.5t and 6t. In embodiments that utilize a second nozzle, the outer surface of the barrel of the second nozzle can extend from the outer curved transition of the second nozzle to the intermediate portion of the barrel of the second nozzle at a distance that is between 0.5t′ and 6t′. In some embodiments, the intermediate portion of the barrel of the first nozzle can taper from the intermediate portion to the interface opening of the second end of the first nozzle. The intermediate portion of the barrel of the second nozzle can also taper from the intermediate portion to the interface opening of the second end of the second nozzle in some embodiments as well.

In a fifteenth aspect, the proximate side of the lip of the first nozzle can be spaced apart from an inner surface of the barrel of the first nozzle defining the inner passageway at the first end of the first nozzle by a distance that is between 2t and 6t such that a joint of the weld between the wall and the distal side of the lip of the first nozzle is a distance of between 2t and 6t from the inner surface of the barrel defining the inner passageway at the first end of the first nozzle. In embodiments that utilize a second nozzle, the proximate side of the lip of the second nozzle can be spaced apart from an inner surface of the barrel of the second nozzle defining the inner passageway at the first end of the second nozzle by a distance that is between 2t′ and 6t′ such that a joint of the weld between the wall of the second end of the body of the vessel and the distal side of the lip of the second nozzle is a distance of between 2t′ and 6t′ from the inner surface of the barrel defining the inner passageway at the first end of the second nozzle.

In a sixteenth aspect, the apparatus configured to utilize cyclic pressurization can be a pressure swing adsorption (PSA) system, a PSA system utilized for carbon dioxide capture, or a buffer tank.

In a seventeenth aspect, the vessel can have a pre-selected diameter. For example, the vessel can have a diameter of at least 1.2 meters (m), or a diameter of between 1.2 m and 3 m or between 1.2 m and 10 m.

In an eighteenth aspect, the ninth aspect for the vessel for an apparatus configured to utilize cyclic pressurization can include other elements or features. For example, the ninth aspect can include one or more features of the tenth aspect, eleventh aspect, twelfth aspect, thirteenth aspect, fourteenth aspect, fifteenth aspect, sixteenth aspect, and/or seventeenth aspect. Embodiments can also utilize other features or elements. Examples of such features or elements can be appreciated from the exemplary embodiments of the vessel discussed herein.

In a nineteenth aspect, a process for providing at least one vessel is provided. Embodiments of the process can include forming a body of a vessel having a first head end wherein the body of the vessel defines a chamber; cutting away a portion of an apex of a first end of the body of the vessel, and attaching a first nozzle to the first end of the body within a hole of the first end of the body formed via the cutting away of the portion of the apex of the first end of the body via welding that forms a weld joint between a distal side of an annular lip of the first nozzle and a wall of the first end of the body of the vessel. The wall of the first end of the body of the vessel can have a thickness (t). The first nozzle can be attached to the first end of the body such that a barrel defining an inner passageway that is attached to the lip of the first nozzle is in fluid communication with a vessel interface opening defined by the lip at a first end of the first nozzle. A second end of the first nozzle opposite the first end of the first nozzle can have an interface opening in communication with the inner passageway. The distal side of the lip can be opposite a proximate side of the lip and the proximate side of the lip can be positioned around an inner end of the barrel to define the vessel interface opening. The proximate side of the lip can be spaced apart from the distal side of the lip by a first distance that is between 4 times a thickness of the wall (t) and 0.75t such that a joint of a weld between the wall and the distal side of the lip is a distance of between 4t and 0.75t from the proximate side of the lip. Embodiments of the process can also include other steps or features.

In a twentieth aspect, the process can be configured and implemented such that the first nozzle is a forged such that the lip and the barrel are integral to each other and the first nozzle does not include an inner projection.

In a twenty-first aspect, the first nozzle utilized in the process can have one or more features of a first nozzle as discussed above.

In a twenty-second aspect, embodiments of the process can also include cutting away a portion of an apex of a second end of the body of the vessel, and attaching a second nozzle to the second end of the body within a hole of the second end of the body formed via the cutting away of the portion of the apex of the second end of the body via welding that forms a weld joint between a distal side of an annular lip of the second nozzle and a wall of the second end of the body of the vessel. The wall of the second end of the body of the vessel can have a thickness (t′). The second nozzle can be attached to the second end of the body such that a barrel defining an inner passageway that is attached to the lip of the second nozzle is in fluid communication with a vessel interface opening defined by the lip at a first end of the second nozzle. A second end of the second nozzle opposite the first end of the second nozzle can have an interface opening in communication with the inner passageway of the second nozzle. The distal side of the lip of the second nozzle can be opposite a proximate side of the lip of the second nozzle and the proximate side of the lip of the second nozzle can be positioned around an inner end of the barrel of the second nozzle to define the vessel interface opening of the second nozzle. The proximate side of the lip of the second nozzle can be spaced apart from the distal side of the lip of the second nozzle by a second distance that is between 4 times a thickness of the wall of the second end of the body of the vessel (t′) and 0.75t′ such that a joint of a weld between the wall and the distal side of the lip of the second nozzle is a distance of between 4t′ and 0.75t′ from the proximate side of the lip of the second nozzle.

Embodiments of the process can also include other steps or features. For instance, in a twenty-third aspect, the process of the nineteenth aspect can include one or more features of the twentieth aspect, twenty-first aspect, and/or twenty-second aspect. Embodiments can also utilize other features or elements. Examples of such features or elements can be appreciated from the exemplary embodiments of the process discussed herein.

In a twenty-fourth aspect, a system for purification of a fluid is provided. Embodiments of the system can include at least one vessel. Each vessel can include a body having a first end and a second end. The first end can have an opening defined therein. The first end can have a wall and the body of the vessel can define a chamber within the vessel. At least one layer of adsorbent material can be positioned within the chamber. A first nozzle can be positioned within the opening defined in the first end of the body. The first nozzle includes a barrel attached to an annular lip. The barrel can define an inner passageway that is in fluid communication with a vessel interface opening defined by the lip at a first end of the first nozzle. A second end of the first nozzle opposite the first end of the first nozzle can have an interface opening in communication with the inner passageway. The lip can have a distal side that is opposite a proximate side. The proximate side can be positionable around an inner end of the barrel to define the vessel interface opening. The proximate side of the lip can be spaced apart from the distal side of the lip by a first distance that is between 4 times a thickness of the wall (t) and 0.75t such that a joint of a weld between the wall and the distal side of the lip is a distance of between 4t and 0.75t from the proximate side of the lip.

Embodiments of the system can be configured so that the at least one vessel includes a plurality of vessels and the system can be configured as a pressure swing adsorption system.

Embodiments may also utilize other features. For example, embodiments of the PSA system can utilize one or more sensors and/or a controller to help monitor and/or control operations of the system. Embodiments of the system can also utilize a second nozzle attached to a second end of the vessel. Exemplary configurations for such a second nozzle can include elements of the above mentioned second nozzle, for example. Other embodiments can include other features or elements as well.

Other details, objects, and advantages of a nozzle, vessel, apparatus, process, and methods of making and using the same will become apparent as the following description of certain exemplary embodiments thereof proceeds.

### BRIEF DESCRIPTION OF THE DRAWINGS

Exemplary embodiments of a nozzle, vessel, apparatus, and methods of making and using the same are shown in the drawings included herewith. It should be understood that like reference characters used in the drawings may identify like components.

FIG. 1 is a schematic diagram of an exemplary embodiment of an apparatus 1 configured to utilize cyclic pressurization of one or more vessels V.

FIG. 2 is a schematic diagram of a first exemplary embodiment of a vessel V having one or more nozzles N that can be utilized in the exemplary embodiment of the apparatus 1.

FIG. 3 is a schematic diagram of a second exemplary embodiment of a vessel V having one or more nozzles N that can be utilized in the exemplary embodiment of the apparatus 1.

FIG. 4 is a perspective view of a first exemplary embodiment of a nozzle N that can be utilized in the first and second embodiments of the vessel V shown in FIGS. 2 and 3.

FIG. 5 is a cross-sectional view of the first exemplary embodiment of the nozzle N shown in FIG. 4.

FIG. 6 is an enlarged fragmentary cross-sectional view of the first exemplary embodiment of the nozzle N shown in FIGS. 4 and 5.

FIG. 7 is a flow chart illustrating a first exemplary embodiment of a process of installation and/or use of at least one nozzle N in a vessel V for use in cyclical pressurization operations (e.g. PSA operations, etc.).

### DETAILED DESCRIPTION OF THE INVENTION

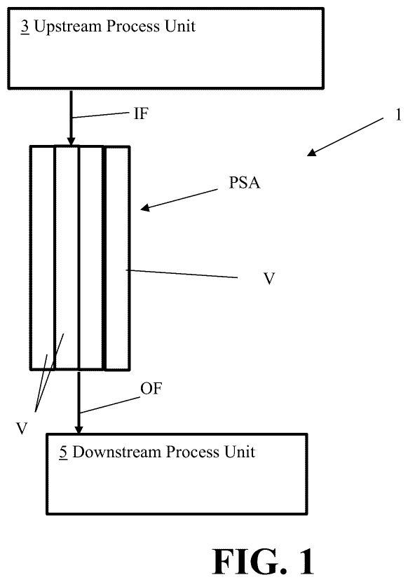

Referring to FIGS. 1-7, an apparatus 1 configured for cyclical pressurization of fluid (e.g. gas, a stream of fluid that is comprised of a gas having hydrogen and other constituents, etc.) can include a system having at least one vessel V. For example, an upstream processing unit 3 can output the fluid for feeding the fluid as an input stream IF to one or more vessels V of the apparatus for pressurization of the fluid. In some embodiments, each vessel V can have at least one layer of adsorbent material therein for adsorption of impurities to form a desired purified gas for outputting an output stream OF to a downstream process unit 5 and/or as a product stream.

Embodiments of the system PSA can be configured to purify a fluid passed through one or more of the vessels V of the system PSA. In some configurations, an array of one or more vessels V can be configured as a pressure swing adsorption system PSA, for example. The pressure swing adsorption system PSA can have an array of vessels V or just a single vessel V positioned to receive an input stream IF from an upstream processing unit 3 to purify that stream to form a purified hydrogen output stream OF in some embodiments in which the system PSA is configured to provide a purified hydrogen stream (e.g. ammonia cracker applications, steam reformer applications, reformer applications, etc.), for example. In such an embodiment, the pressure of the vessel can be cycled between a lower pressure condition and a higher pressure condition to facilitate adsorption of impurities from the fluid of the input stream to purify that fluid via the adsorbent material within the vessel for outputting the output stream OF. In other configurations, the system PSA can be configured to undergo cyclical pressure between low and high pressure conditions for other applications (e.g. in other type of pressure swing adsorption systems for purification of another type of fluid, for other type of cyclical pressurization operations, etc.).

While embodiments of the nozzle can be utilized in all types of PSA vessels, there is an emerging class of PSA systems for which embodiments of our nozzle can provide significant improvements in terms of fabrication, maintenance, and cost. These emerging PSA systems often utilize adsorbents designed for short cycle times in order to offer increased productivity from the adsorbent and vessel volume. The additional pressure swing cycles per unit time would conventionally require a thicker vessel wall to maintain a similar design life as more traditional PSA cycles. These cycle times may be 50%, 10%, or even less of traditional cycle times. The adsorbents which enable such short cycles may have any of the following structures: smaller particle sizes, monolith, laminate, perforated particles, corrugated sheets, and other designs to provide short macropore diffusion paths and/or lower pressure drop. Embodiments of our nozzle can be employed in such vessels to provide significant weight reductions, ease of fabrication and transportation benefits, and reduced cost benefits for the vessels designed to be utilized in such applications.

While many applications may benefit from the high productivity of such rapid cycle PSA processes, the capture of carbon dioxide from the atmosphere, flue gas, precombustion, or other sources can be especially suitable for use in such rapid cycle processes due to the extremely larger gas flow rates required for such processing.

Another application where a vessel V can be configured for cyclic pressurization is in buffer tank applications. Generally in these applications flow rate into the vessel V can be variable while flow rate out of the vessel V can be relatively consistent. This can cause cyclic pressure fluctuations in which embodiment of the nozzle can allow for an improved design that can provide the fabrication, installation and maintenance improvements discussed herein.

Each vessel of the system PSA of vessels V can include a wall WL that defines an inner chamber VC therein. The vessel V can have a first end E1, a second end E2, a length VL between those first and second ends and a width or diameter VD that is a distance between the opposite sides of the vessel that extend between the first and second ends to define the length VL of the vessel (e.g. the width or diameter VD of the vessel V can extend in a direction that is perpendicular to the length VL of the vessel V). In some embodiments, each end of the vessel can have a tapered diameter and/or can have a head VH, which can be a formed head VH (e.g. an elliptical head, a torispherical head, a hemispherical head, a conical head, a flat head etc.).

In embodiments in which the vessel head VH is a flat head configuration, the flat head can be attached directly to a shell (which can be an intermediate tubular body VB) of the vessel via welding or similar type direct attachment process or the flat head can be mechanically fastened (e.g. bolted) and be structured as a blind flange or similar arrangement.

In some embodiments, the inner chamber VC can be sized to receive and retain a bed of one or more layers of adsorbent material therein. The adsorbent material can include Cax, molecular sieve material, alumina, silica, silica gel, activated carbon, zeolite material, other types of adsorbent material or combinations thereof.

In some configurations, the vessel V can be oval or canister shaped vessel V that has ends configured as heads VH between a tubular intermediate body VB to define the vessel shape defining the vessel chamber VC. In some embodiments, the tubular intermediate body VB can be considered a shell that is attached to heads (e.g. elliptical heads, hemispherical heads, torispherical heads, etc.) to define the first and second ends E1 and E2 of the vessel at opposite ends of the intermediate tubular body VB such that the intermediate tubular body VB is between the heads VH at the opposite ends of the vessel V.

The first end E1 and/or the second end E2 can have a head VH that can be considered a formed head, a hemispherical head, an elliptical head, a torispherical head, or other type of similar geometry type head configuration. For instance, in some embodiments, the head of the end of the vessel V can be an elliptical head, such as, for example, a 2:1 elliptical head. This type of elliptical head can be an example of a head VH of the vessel. As another example, in some embodiments, the head end of the vessel for each end can be a 90-17 torispherical head, or another type of hemispherical head having a similar type of geometry for each end of the vessel V.

In some configurations, the vessel body can be formed as a fully enclosed canister body, for example. After the initial vessel body is formed with its length, diameter, ends, and internal chamber VC enclosed within the body of the formed vessel V, a first interface opening can be cut out at the first end E1 of the vessel and a second interface opening can be cut out of the second end E2 of the vessel to provide openings in which nozzles N can be positioned to facilitate fluidly connecting the vessel V to an upstream processing unit 3 and a downstream processing unit 5. In other embodiments, only a first end E1 of the vessel may have an opening cut out of it to define a first interface for receipt of a first nozzle N. In yet other configurations, at least one interface opening may be cut from a wall WL of the vessel at a side of the vessel instead of at least one end of the vessel V.

The one or more walls WL of the vessel can define the outer perimeter of the vessel V that defines the internal chamber VC of the vessel. In some configurations, the wall WL can be a single wall that is formed to define the vessel body. In other configurations, the vessel can include a wall that defines a tubular intermediate body section and walls WL that define formed heads VH of the first and second ends E1, E2, of the vessel V. The one or more walls WL can have a thickness WT. The thickness of the wall WL can vary among the vessel head(s), shell sections, and other components of the vessel V.

Each head VH can be attached to an opposite end of the tubular intermediate body to define the vessel V and internal chamber VC of the vessel. In some embodiments, an interface hole can be cut out of an end of each head VH or only a single one of the heads VH to define an opening for receipt and attachment of a nozzle N as noted above as well. Also (or alternatively), a side of the vessel can have at least one hole cut out of it for providing at least one interface opening for attachment of at least one nozzle N as discussed above (e.g. a respective nozzle N can be positioned in a respective interface opening for attachment to the body of the vessel V).

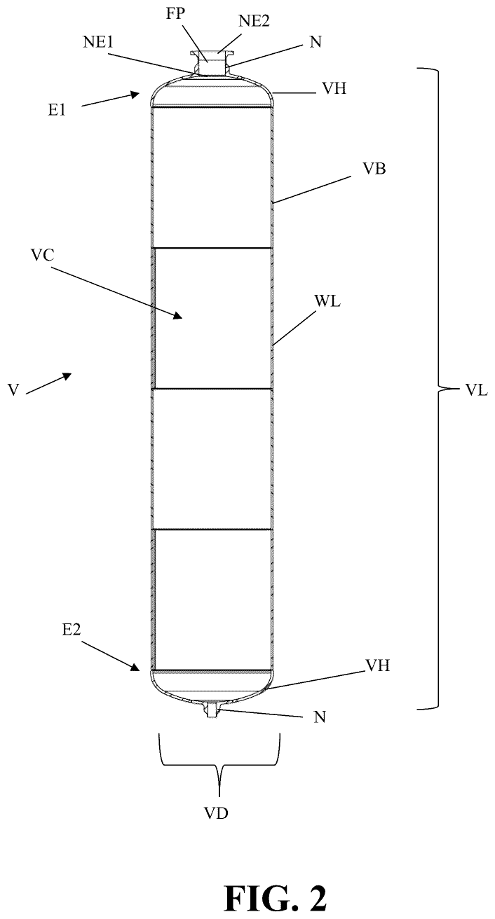

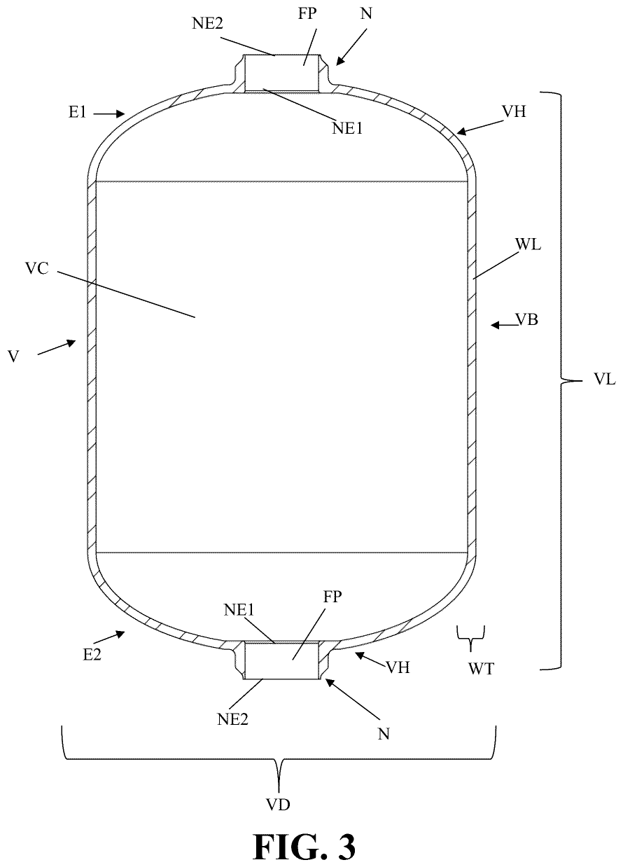

The vessel V can have any of a number of suitable shapes. FIGS. 2 and 3 illustrate exemplary embodiments of vessels that have different lengths VL and width or diameters VD. Other embodiments of vessels V can be longer or shorter and/or wider or thinner. Othe embodiments can also have other shapes of the vessel V as well.

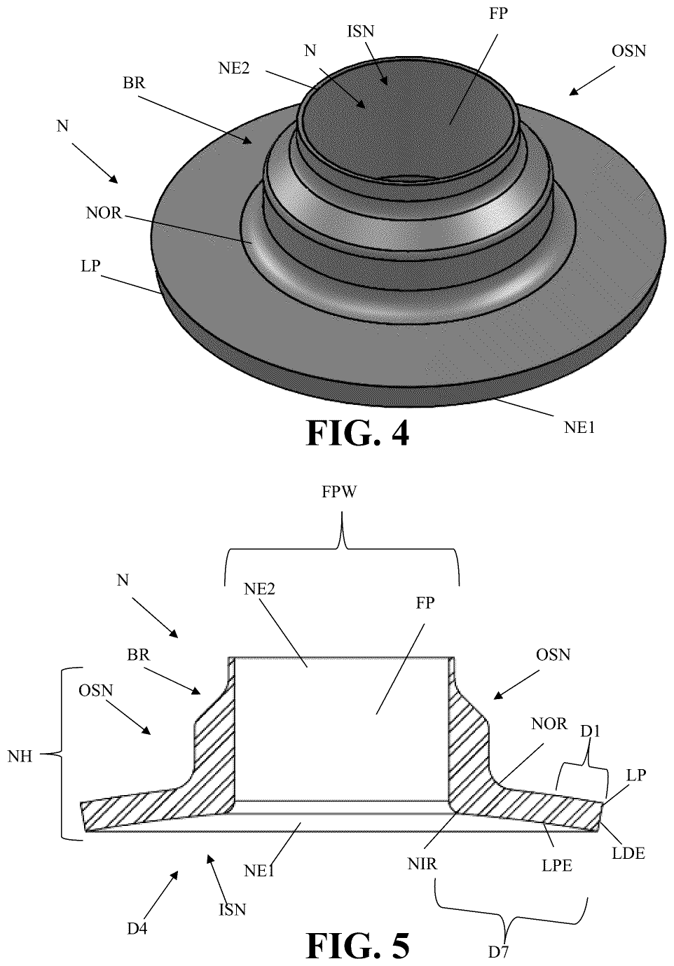

As may best be appreciated from FIGS. 4-6, an exemplary embodiment of each nozzle N attached to the body of the exemplary embodiments of the vessel V shown in FIGS. 2 and 3, which can be utilized in an embodiment of the apparatus 1 shown in FIG. 1, can have a specific shape or geometry for meeting a pre-selected set of design criteria to allow for the wall thickness WT for one or more vessel walls WL to be relatively thin while still being able to meet stress design constrains and/or other pre-selected performance criteria. The first nozzle attached to a first end E1 of the vessel and a second nozzle attached to a second end E2 of a vessel V can have the same design as an embodiment shown in FIGS. 4-6. In other embodiments, only a single end of the vessel may have such a nozzle and the other end may not have a nozzle or may have a different nozzle. In yet other embodiments, a nozzle can be attached to a sidewall of the vessel instead of at an end of the vessel as noted above.

Each nozzle N that is utilized can have a similar structure or design, be the same in shape and structure, or may have a different structure or geometry. For example, the thickness of the head of the first end E1 of the vessel can be different than the thickness of the head of the second end E2 of the vessel, which can be different than the thickness of the vessel shell, or intermediate portion of the vessel that is between the first and second ends. Each nozzle N can be configured for the shape and thickness of the head to which the nozzle is to be attached.

For example, the nozzle N attached to the first end E1 and/or the second end E2 can have a barrel BR that extends between an inner end NE1 and an outer end NE2. The inner end NE1 (which can also be referred to as a first end), of the nozzle N can be configured for attachment to a head VH of the vessel V at the first end E1 or second end E2 of the vessel V. The outer end NE2 of the nozzle N (which can also be referred to as the second end of the nozzle N) can be positioned at an opposite end of the barrel BR from the inner end NE1, or first end of the nozzle. The outer end NE2 can be positioned and configured to facilitate fluid connection with a conduit or other process element that is upstream or downstream of a vessel V of the apparatus 1. The barrel BR of the nozzle N can have an inner passageway FP defined therein. The inner passageway FP can be defined to have a width or diameter FPW that extends between opposite sides of the barrel BR between the inner end NE1 and the outer end NE2 of the nozzle N. The inner passageway FP can extend from a vessel interface opening defined in the inner end NE1 of the nozzle to an interface opening defined in the second end NE2 of the nozzle to define a length of the inner passageway. The length of the inner passageway can be the same or similar to the height of the nozzle NH, which can extend in a direction that is perpendicular to the direction the width or diameter FPW of the inner passageway FP extends between opposite sides of the barrel BR. These opposite sides of the barrel BR can extend between opposite ends of the barrel, or between the inner end NE1 and outer end NE2 of the nozzle N.

The inner passageway FP can be sized and configured so that the vessel interface opening of the inner end NE1 is in fluid communication with the interface opening defined in the second end NE2 of the nozzle. The body of the nozzle can have a pre-selected shape or configuration to facilitate positioning of the inner passageway FP of the nozzle at a desired location while also permitting an interface at which the nozzle is attachable to the vessel V to be at a pre-selected location that can experience a pre-selected level of stress during exposure to cyclical pressure operations (e.g. pressure adjustments between high and low pressure conditions that may repeatedly occur in numerous cycles during pressure swing adsorption processing or other cyclical pressure processing).

For example, the inner end NE1 of the nozzle can have an annular lip LP. the annular lip can extend outwardly from the vessel interface opening of the inner end NE1 of the nozzle so that the inner end NE1 is wider than the second end NE2 of the nozzle N. In other embodiments, it is contemplated that the second end NE2 of the nozzle N may also have an annular lip configuration similar to that of the first end.

The nozzle can also be shaped and configured so that the lip LP of the nozzle has a distal side LDE and a proximate side LPE that is opposite its distal side LDE. The distal side LDE can be wider and farther from a barrel BR of the nozzle N than the proximate side LPE of the lip LP. The proximate side LPE can be considered a proximate end or inner edge of the annular lip that defines the vessel interface opening of the inner end NE1 of the nozzle that can be in fluid communication with the inner passageway FP of the barrel. The distal side LDE can be considered an outer end or outer edge of the annular lip LP. The lip LP can extend from its proximate side LPE to its distal side LDE along a curved contour to define a contoured annular lip LP that is curved to match a curvature of the portion of an end of the vessel E1 that can be cut out of the vessel for forming the opening in which the nozzle N is to be positioned.

The proximate side LPE of the lip LP can be integral with the barrel BR of the nozzle so that the inner surface of the nozzle between the lip LP and the barrel BR defines an inner curved transition NIR that extends from the proximate side LPE of the lip LP to the inner surface of the barrel BR that defines the substantial part of the inner passageway FP between the vessel interface opening of the inner end NE1 and the interface opening defined in the second end NE2 of the nozzle N. The interface opening defined in the second end NE2 of the nozzle can be an outer end opening of the inner passageway FP of the barrel BR that is opposite the vessel interface opening of the inner end NE1, for example.

The barrel BR can be configured to have a constant thickness, or a variable thickness. The barrel BR can also include one or more elements that can project or protrude from the nozzle N and into an interior of the vessel V (e.g. the chamber VC of the vessel, etc.).

An outer surface OSN of the nozzle N can be the surface of the nozzle that is positioned away from the vessel and/or opposite the inner surface ISN of the nozzle that interfaces with the chamber VC of the vessel V and defines the inner passageway FP of the nozzle N. The inner surface ISN of the nozzle N can be a vessel facing surface of the annular lip and inner surface of the barrel BR that defines the inner passageway FP, for example. The outer surface OSN of the nozzle can be the opposite surface of the nozzle that is an external surface positioned to face outwardly away from the vessel chamber VC.

The inner curved transition NIR can be defined on the inner surface ISN and an outer curved transition NOR between the proximate side LPE of the lip LP and the barrel BR can be defined on the outer surface OSN of the nozzle N. The outer curved transition NOR can extend from the proximate side LPE of the lip LP to the outer surface of the barrel BR along the outer surface OSN of the nozzle N.

The annular lip LP of the nozzle N can be sized and configured to facilitate attachment of the nozzle's inner end NE1 to an end of a vessel V (e.g. a head VH of a vessel, an apex region of a formed head VH of the vessel, etc.). Other elements of the nozzle N (e.g. barrel BR, outer surface OSN and inner surface ISN, inner curved transition NIR, outer curved transition NOR, etc.) can also be sized and configured to facilitate attachment of the nozzle N to the vessel V so that the locations at which the nozzle can be welded to the end of the vessel can be a relatively low stress region so that a thickness of a formed heat VH or wall WL of the vessel can be kept relatively thin.

The thickness of the lip LP can be configured to be the same thickness as the head VH or can be thicker than the head VH. The lip LP can have a constant thickness or a variable thickness.

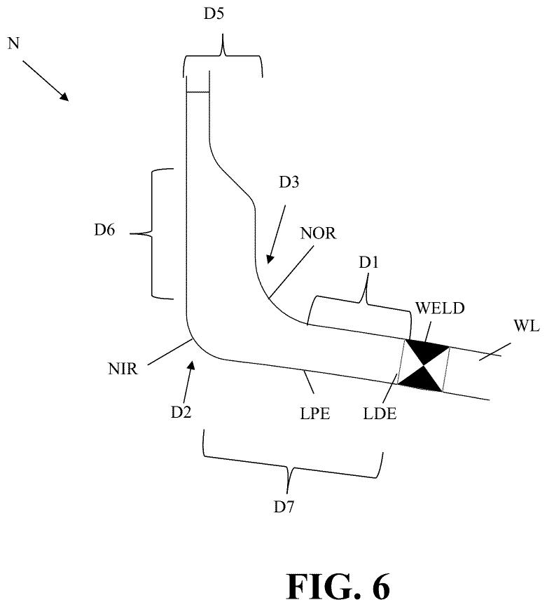

In some embodiments, the nozzle N can include a lip LP having a first dimension to facilitate nozzle attachment to the wall WL of the vessel adjacent an end of the vessel in which the weld joint (WELD) for attachment of the nozzle to the vessel body (e.g. head VH of the vessel) is located at a distance D1 that is between 4 times the wall thickness WT of the wall WL and 0.75 times the wall thickness WT of the wall WL (e.g. 1-2.5 times the wall thickness WT, 1.5-2.5 times the wall thickness WT, etc.) to a proximate side LPE of the lip LP of the nozzle N. This distance D1, in some embodiments, can be between 2.5 cm and 51 cm, 2.5 cm and 10 cm, 3.7 cm to 6.25 cm, 12.5 cm to 51 cm, or 18 cm to 38 cm, where the wall thickness WT may be between 2.5 cm and 12.7 cm. This distance D1 can be a first dimension that can help facilitate welded attachment of the nozzle to al head end of the vessel V within a hole cut from that formed end. The welding can be provided to form a weld joint WELD between the wall WL and the distal side LDE of the lip (as may best be appreciated from FIG. 6). The welded joint WELD can be formed via a butt weld formed to weld the distal side of the lip LDE to the wall of the head VH for attachment of the nozzle N to the end of the vessel V. This welding can provide an integral attachment of the nozzle to the end of the vessel V that is fluid-tight (e.g. avoids fluid leaking from between the nozzle N and the wall WL to which the nozzle is welded). The welded joint can be defined in a ring-like shape around an entire periphery of the distal side LDE of the lip LP (e.g. be an annular shaped weld joint, or a ring-shaped weld joint WELD, which can correspond to the shape of the distal side LDE of the lip LP).

The wall thickness WT can also be referred to as the thickness “t” herein. For example, the distance D1 noted above can be between 0.75t and 4t (e.g. 1t-4t, 1.5t-4t, 1t-2.5t, 1.5t-2.5t, etc.). The distance D1 can be the distance between the distal side LDE of the lip and the proximate side LPE of the lip LP. For example, the distance D1 can define a surface area of the lip LP, which can be the difference between the outer diameter of the lip that can be defined by the distal side LDE and the inner diameter of the lip that can be defined by the annular shaped proximate side LPE.

The inner curved transition NIR can be defined to provide a transition between the proximate side LPE of the lip LP of the nozzle N and the inner wall segment of the barrel BR that define the inner pathway FP through the opening of the nozzle in which the inner curved transition NIR has a curved transition segment of the inner surface NIS of the nozzle N as a radial segment that extends a distance D2 along a radius of between 0.5t and 2t (e.g. 0.8t-1.2t, 0.6t-1.4t, etc.). This distance D2, in some embodiments, can be between 1.25 cm and 25 cm, 2 cm and 3 cm, 6.35 cm to 25 cm, 10 cm to 16 cm, or 12.5 cm to 18 cm when the wall thickness WT may be between 2.5 cm and 12.7 cm. In some configurations, the inner curved transition NIR can be an inner radius.

The outer curved transition NOR that can be positioned to provide a transition between the proximate side LPE of the lip LP and the outer surface of the body of the barrel BR of the nozzle N that defines the inner pathway FP of the nozzle can extend along a radius distance D3 that is between 0.5t and 3t (e.g. 1.5t to 1t, 0.75t to 2t, etc.). This distance D3, in some embodiments, can be between 1.25 cm and 39 cm, 2.5 cm and 3.8 cm, 6.25 cm to 39 cm, 12.5 cm to 19 cm, or 8 cm to 25 cm where the wall thickness WT may be between 2.5 cm and 12.7 cm. In some configurations, the outer curved transition can be an outer radius.

The lip LP of the nozzle can be contoured to provide a contoured lip LP having a contoured dimension D4 that is sized to match or substantially match (e.g. being 0.8-1.1 or being 0.9 to 1.0 of a match) the curvature of the portion of the head of the vessel that was cut away to form the opening in which the nozzle is to be positioned. For instance, the annular lip LP and/or the inner end NE1 of the nozzle N can be shaped and contoured to have a pre-selected structured dimension to facilitate a matching position in an opening cut in the end of the vessel to which the nozzle is to be attached to facilitate a sealed weldable attachment between the first end, or inner end NE1, of the nozzle and the end of the vessel V. This matching or substantially matching condition can permit the contoured lip LP to mimic a substantial portion of the vessel head that was removed for positioning and attachment of the nozzle N therein.

The nozzle N can be positioned so that the nozzle replaces the removed portion of the head of the vessel V. For example, the nozzle N can be positioned within the hole formed by the removal of that portion of the head VH of the vessel V in some embodiments. The weld joint WELD can be provided between the distal edge or outer side of the lip LP and the portion of the head VH to integrally attach the nozzle N to the head VH.

The thickness D5 of the annular wall of the nozzle that defines the barrel BR of the nozzle can be between 0.5t and 3t (e.g. 1.5t-1t, 1.2t-2.5t, 1t-2t, etc.). This distance D5, in some embodiments, can be between 1.25 cm and 39 cm, 2.5 cm and 3.8 cm, 6.25 cm to 39 cm, 12.5 cm to 19 cm, or 12.5 cm to 25 cm where the wall thickness WT may be between 2.5 cm and 12.7 cm. This thickness can be a thickness located an intermediate portion of the barrel BR that extends from the inner opening of the vessel interface opening of the first end NE1 of the nozzle to a portion of the inner passageway FP that corresponds to a location at which an outer surface OSN of the nozzle on the barrel tapers to a thinner dimension adjacent the second end NE2 of the nozzle N.

The length of the outer surface of the barrel extending from the outer curved transition NOR to a location of the barrel adjacent the outer end NE2 of the nozzle N at which the thickness D5 of the annular wall of the barrel BR begins to taper is a distance D6 that is between 6t and 0.5t (e.g. 0.5t-5t, 1t-5t, 1.5t-4t, etc.). This length can be from the intermediate portion of the barrel at which the barrel begins to taper to the outer curved transition NOR, for example. This distance D6, in some embodiments, can be between 1.25 cm and 78 cm, 1.25 cm and 64 cm, 6.25 cm to 39 cm, 12.5 cm to 19 cm, or 12.5 cm to 50 cm where the wall thickness WT may be between 2.5 cm and 12.7 cm.

The nozzle N can also be structured so that the lip LP and barrel BR are configured such that there is a distance D7 between the inner diameter of the nozzle passageway FP and the weld joint WELD that is to be integral to the distal edge of the lip of the nozzle for attachment of the nozzle N to a vessel wall of a vessel head VH or shell that is greater than 2t (e.g. is between 2t and 8t, is 2.5t-7t, is 2.5t-6.5t, is 2t-5t, 3t-6t, 4t-6t, etc.). For example, the distance D7 can extend from the distal side LDE of the lip LP to the inner surface of the barrel BR that defines the inner passageway FP at the inner end NE1 of the nozzle N can be between 2t and 8t (e.g. is 2.5t-7t, is 2.5t-6.5t, is 2t-5t, 3t-6t, 4t-6t is greater than 2t and less than or equal to 8t, etc.). This distance D7 can be considered a seventh dimension in some embodiments. In embodiments where the distance D7 is utilized with other dimensional features, it may be considered one of the different dimensional features (e.g. a second dimension, a third dimension, a fourth dimension, a fifth dimension, etc.).

The nozzle N can also be configured so that it does not have any internal projections. Also, the nozzle N can be shaped and configured so that the geometry of the nozzle is configured so that the stress concentration factor is approximately equal to, or less than the maximum stress concentration factor in the formed head VH of the vessel, which is generally in the knuckle region (wherein the knuckle of the head VH can be a more spherical or elliptical distal end having the most curvature). The maximum stress concentration factor can also be in a conical section of the vessel.

The stresses at a nozzle N are generally higher in a region close to the nozzle/vessel head junction and can decrease as the distance away from the discontinuity increases. The distance between the weld joint WELD and the inner curved transition NIR and outer curved transition NOR of the nozzle can be pre-selected so that the stress at the weld joint WELD was reduced to be at or below a pre-selected stress level. In some embodiments, the pre-selected stress level value can be a value that is the inverse of the FSRF compared to a pre-selected maximum stress value. The pre-selected maximum stress value can be defined by a vessel stress design specification or a code that can define a maximum stress for the vessel.

For example, we surprisingly found that, among the range of typical PSA vessel dimensions, a distance D1 that is between the distal end of the lip and the proximate side LPE of the lip LP to which the outer curved transition NOR and/or inner curved transition NIR may be integral with can be pre-selected to help lower the stress experienced by the weld joint WELD region. For example, we have surprisingly found that a distance D1 that is between 4 times the wall thickness WT of the wall WL and 0.75 times the wall thickness WT of the wall WL (e.g. approximately 2 times the thickness WT of the wall of the vessel head, etc.) can permit the weld joint to be at a location that can significantly reduce the stress experienced by the weld during cyclical pressurization operations. We also found that with the weld joint WELD located further away from the inner passageway FP of the nozzle, it would add cost to the manufacture of the nozzle design by making the forging of the nozzle N larger than necessary. In contrast, if the weld joint WELD was located closer to the nozzle, we surprisingly found that it would add cost by requiring a thicker wall for the head VH, and that this added cost is substantially greater than the cost that may be incurred by use of the larger and higher cost nozzle design.

We have found that by increasing the distance D1, the stress at the weld may no longer be a limiting component for determining the thickness of the head to which the nozzle is to be attached. Also, additional dimensions for the nozzle can be configured to provide further improvement. For example, high stresses can be found at the nozzle inner curved transition NIR and the nozzle outer curved transition NOR and increasing the radius of the second distance D2 can help decrease the stresses at the nozzle inner curved transition NIR and increasing the third distance D3 can help decrease the stress at the nozzle outer curved transition NOR. Also, the thickness D5 of the barrel BR and the length D6 of the outer surface of the barrel extending from the outer curved transition NOR to a location of the barrel adjacent the outer end NE2 of the nozzle N at which the thickness D5 of the annular wall of the barrel BR can also decrease the stresses at the nozzle inner curved transition NIR and nozzle outer curved transition NOR. These variables can be defined to meet a particular set of design criteria to facilitate a design of an overall lower cost vessel that can provide improved maintenance functionality, provide a safety improvement, and also permit the vessel to have a lower overall capital cost and weight.

For example, we have also surprisingly found that by configuring the nozzle N so that the weld joint WELD for attachment of the nozzle to an end of the vessel was located at least 2 times the thickness of the end away from the nozzle permitted a number of advantages. For example, the reduction in the stress associated with this weld location was able to permit the thickness WT of the vessel wall(s) WL to be much thinner, such that the overall mass of the vessel having the nozzle(s) was much lower and the overall cost of the vessel could be significantly reduced.

Also, the larger lip (e.g. larger distance D1) sizing to the nozzle N can provide other advantages. For instance, from a maintenance perspective, the larger nozzle N can be sized so that the ultrasonic inspection of the weld is more easily accomplished by allowing a more comprehensible inspection of the nozzle from the outside surface of the vessel. For instance, a probe can be passed through the inner passageway FP of the larger nozzle and more easily moved around inside the vessel to better inspect the weld joint WELD via an interior probe position while an operator may be located external to the vessel (e.g. on an outer surface of the vessel or adjacent the outer surface OSN of the nozzle). This improved use can make ultrasonic inspection occur more quickly and easily while also providing a more thorough and reliable inspection. This can reduce maintenance time while also providing improved maintenance performance that can improve the safety in operation of the vessel(s) V.

We surprisingly found that there can be a general shortcoming with most code-based methods to calculate stress at a nozzle for a vessel because there is typically no attempt to calculate the stress at the weld separately from the base metal of the vessel. In our experience, many methods for calculating stress do not consider where the weld is located, and therefor, do not have guidelines on where to locate the weld. However, we have found that when the stress in the weld joint WELD can be much less than the maximum stress, that this can permit a significant reduction in the overall thickness of pressure vessel components. While the nozzle itself may be larger and cost more to provide such a stress reduction, we surprisingly found that the overall mass of the vessel and the cost of the vessel can be reduced by such a feature due to the decreased stress experienced at the weld joint WELD.

Also, we have surprisingly found that use of other dimensional elements of the nozzle can help further enhance the stress reduction that can be provided by the location of the weld joint WELD that may be provided by a pre-selected sizing of the contoured lip LP of the nozzle. For example, the sizing of the inner curved transition NIR having a distance D2 of between 0.5t and 2t and/or outer curved transition NOR having a distance D3 that is between 0.5t and 3t as noted above can be utilized in combination with the lip having a distance D1 between its distal side LDE and proximate side LPE that is between 4t and 0.75t. We have surprisingly found that the curvature and length thereof that can be provided by use of the inner curved transition NIR and/or outer curved transition NOR can help further enhance the stress reduction provided by the lip LP sizing. This type of additional set of features can also provide an increase in design flexibility for the nozzle N to provide reduced stresses at the weld joint WELD region that can allow the thickness of the vessel wall(s) WL to be reduced to a thinner wall thickness WT.

Additionally, we have found that the thickness D5 of the annular wall of the nozzle that defines the barrel BR of the nozzle being between 0.5t and 3t and the length of the outer surface of the barrel extending from the outer curved transition NOR to a location of the barrel adjacent the outer end NE2 of the nozzle N at which the thickness D5 of the annular wall of the barrel BR begins to taper is a distance D6 that is between 6t and 0.5t can provide additional further design flexibility to help reduce the stress that may be experienced at the weld joint WELD to provide yet additional flexibility in nozzle design for providing a reduction in vessel well thickness WT while keeping the overall stress at or below a pre-selected maximum level. The combination of these five dimensional features can be tailored to meet a pre-selected set of design criteria to provide such functionality while also permitting enhanced maintenance functionality as noted herein.

Finally, we have found that the lip LP being contoured to provide a dimension D4 that can be sized to match or substantially match of the curvature of the portion of the head of the vessel that was cut away to form the opening in which the nozzle N is to be positioned can help further contribute to stress reductions at the weld joint WELD (e.g. being 0.8-1.1 or being 0.9 to 1.0 of a match in curvature). This additional feature can be included with the other above noted features to provide yet further design flexibility for embodiments of the nozzle N.

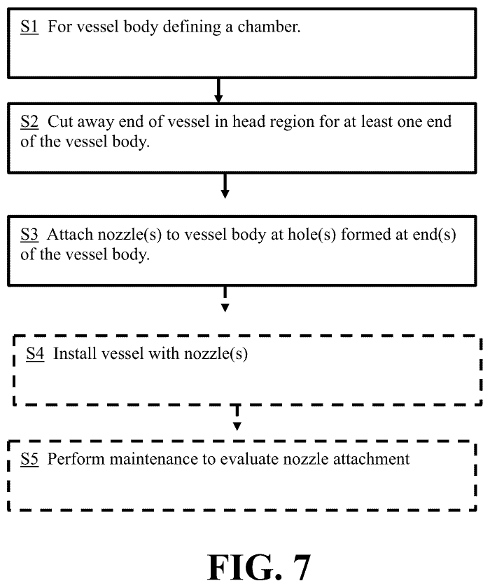

FIG. 7 illustrates an exemplary process for providing a nozzle N for attachment to a vessel for use in cyclical pressure operations (e.g. PSA operations, etc.). In a first step S1, a vessel V having a vessel body can be formed to define a chamber VC within the vessel. The chamber VC can be sized and configured to retain at least one bed of adsorbent material and the vessel V can be formed to fully enclose the chamber VC (e.g. via a metal molding operation, etc.).

In some embodiments, each end of the vessel can be formed to have a formed head VH. In other embodiments the vessel intermediate tubular body VB may be formed and the formed heads VH may be formed separately and subsequently attached to the tubular body VB to define the vessel body and vessel chamber VC within that body.

In a second step S2, at least one end of the vessel V (e.g. first end E1 and/or second end E2) can have a portion cut away to define an opening therein that can be in fluid communication with the inner vessel chamber VC. The formed, cut out opening can be at an apex of a formed head VH of an end of the vessel V, for example. Each end can have such a cut away portion removed to form an opening such that there is a first nozzle receiving opening in a first end E1 of the vessel and a second nozzle receiving opening in a second end E2 of the vessel V. In other contemplated embodiments, there may only be a single opening. In yet other embodiments, it is contemplated that the one or more cut away openings may be at a side or opposite sides of the vessel or other location for a particular application or meeting a particular set of design objectives.

In a third step S3, a nozzle N can be positioned in each defined opening formed in the second step S2 for attachment to the vessel. For instance, a first nozzle N can be positioned in a first opening in a first end E1 of the vessel for being welded to the vessel wall WL via an annular weld joint WELD. Also, a second nozzle N can be positioned in a second opening in a second end E2 of the vessel V for being welded to the vessel wall WL via an annular weld joint WELD.

In a fourth step S4 (shown in broken line), the vessel V having the nozzle(s) N attached thereto from the third step S3 can be installed at an installation. For instance, one or more of such vessels V can be incorporated into a PSA system or other type of apparatus 1 that can be configured for cyclical pressurization of fluid. In some embodiments, for example, the vessel V with the nozzle(s) N can be incorporated into a PSA utilized to form a hydrogen product gas in ammonia cracking and/or reformer processing plants.

In a fifth step S5 (shown in broken line), the apparatus 1 having the one or more vessels V can be utilized and subsequently have maintenance performed on the vessel(s) V. The performance of maintenance can include utilization of a probe used to emit ultrasounds for ultrasonic inspection. An operator can be positioned external to the vessel and pass a probe through the inner passageway FP of the nozzle to obtain data from the probe emitted ultrasonic waves toward the weld joint WELD from within the vessel's chamber VC or inner passageway FP. This can permit the maintenance to occur more easily and quickly while also providing more reliable ultrasonic testing data for evaluation of the weld joint WELD and structural integrity of the vessel. Such maintenance improvements can reduce vessel downtime and improve the accuracy of the monitored structural integrity to help improve the safety in operation of the vessel V.

Embodiments of the process shown in FIG. 7 can utilize one or more embodiments of the nozzle N and/or one or more embodiments of the vessel V and/or apparatus 1. Further, embodiments of the process can provide one or more of the above noted advantages associated with reduced weight vessels in addition to the improved maintenance and safety features. the overall weight reduction for each vessel V can also provide other improvements in design flexibility and in delivery and installation due to the reduced weight, which can make installation work and transportation work easier and less costly.

We have found that an embodiment of a vessel having nozzles N at each end of the vessel can result in an overall mass reduction in the vessel V to provide a vessel to be between $5,000 and $40,000 lower in cost for many common sizes of vessels for different types of pressure swing adsorption (PSA) applications. For PSA systems that may have between 4 and 12 vessels, this type of capital cost savings can be between $20,000 and $480,000 in terms of capital costs. We have surprisingly found that this type of capital cost saving can be provided even through the nozzle component of the overall cost may be significantly higher as compared to conventional nozzle designs.

Moreover, we have found that the overall mass reduction can be significant. This reduction in mass can make installation operations easier to perform and transportation of the vessel(s) V to a particular site to be easier and less costly.

Further, as noted above, embodiments can provide improved maintenance functionality that can permit maintenance operations to be performed more easily and quickly. The performable maintenance can also be performed to provide improved data collection so a more reliable evaluation of the vessel's structural integrity can be obtained (e.g. via ultrasound evaluation) as discussed above. This type of improvement can also improve the safety in operation of the vessel.

It should also be appreciated that other modifications can also be made to meet a particular set of criteria for different embodiments of the apparatus 1 or process. For instance, the positioning of the nozzles for inlet and outlet openings of a vessel can be positioned at different locations and/or utilize other features for coupling with a conduit (e.g. flange elements, mechanical fasteners, etc.) for interconnecting the vessel with different units of an apparatus for fluid communication of the flows of fluid between different elements.

As yet another example, the material composition of the vessel and nozzles can be any type of suitable metal or other material suitable for a particular application or a particular set of design criteria. As yet another example, embodiments of the vessel, nozzle(s), and/or other elements of an apparatus or process can each be configured to include process control elements positioned and configured to monitor and control operations (e.g., temperature and/or pressure sensors, flow sensors, an automated process control system having at least one work station that includes a processor, non-transitory memory and at least one transceiver for communications with the sensor elements, valves, and controllers for providing a user interface for an automated process control system that may be run at the work station and/or another computer device of the plant, etc.). It should be appreciated that embodiments can be configured to utilize a distributed control system (DCS) for implementation of one or more processes and/or controlling operations of an apparatus or process as well.

As another example, it is contemplated that a particular feature described, either individually or as part of an embodiment, can be combined with other individually described features, or parts of other embodiments. The elements and acts of the various embodiments described herein can therefore be combined to provide further embodiments. Thus, while certain exemplary embodiments of the nozzle N, vessel V, process, apparatus 1, system PSA, and methods of making and using the same have been shown and described above, it is to be distinctly understood that the invention is not limited thereto but may be otherwise variously embodied and practiced within the scope of the following claims.

1. A nozzle for a pressure vessel that is sized for being welded to a wall of the vessel, the nozzle comprising:
a barrel attached to an annular lip, the barrel defining an inner passageway that is in fluid communication with a vessel interface opening defined by the lip at a first end of the nozzle, a second end of the nozzle opposite the first end of the nozzle having an interface opening in communication with the inner passageway;
the lip having a distal side that is opposite a proximate side, the proximate side being positionable around an inner end of the barrel to define the vessel interface opening; and
the proximate side of the lip being spaced apart from the distal side of the lip by a first distance that is between 4 times a thickness of the wall (t) and 0.75t such that a joint of the weld between the wall and the distal side of the lip is a distance of between 4t and 0.75t from the proximate side of the lip.

2. The nozzle of claim 1, wherein the nozzle has an inner curved transition that is positioned to extend between the proximate side of the lip and the inner passageway of the barrel, the inner curved transition extending a distance of between 0.5t and 2t.

3. The nozzle of claim 2, wherein the nozzle has an outer curved transition that is positioned to extend between the proximate side of the lip and the barrel, the outer curved transition extending a distance that is between 0.5t and 3t.

4. The nozzle of claim 3, wherein an annular wall of the barrel that defines the inner passageway has a thickness at an intermediate portion of the barrel that is located between the vessel interface opening and the interface opening of the second end of the nozzle, the thickness at the intermediate portion of the barrel being between 0.5t and 3t.

5. The nozzle of claim 4, wherein an outer surface of the barrel extends from the outer curved transition to the intermediate portion of the barrel is a distance that is between 0.5t and 6t.

6. The nozzle of claim 5, wherein the barrel tapers from the intermediate portion to the interface opening of the second end of the nozzle.

7. The nozzle of claim 1, wherein the nozzle has an outer curved transition that is positioned to extend between the proximate side of the lip and the barrel, the outer curved transition extending a distance that is between 0.5t and 3t.

8. The nozzle of claim 7, wherein an outer surface of the barrel extends from the outer curved transition to an intermediate portion of the barrel at a distance that is between 0.5t and 6t, the intermediate portion of the barrel being located between the vessel interface opening and the interface opening of the second end of the nozzle.

9. The nozzle of claim 8, wherein the barrel tapers from the intermediate portion to the interface opening of the second end of the nozzle.

10. The nozzle of claim 1, wherein the lip is contoured to substantially match a contour of a portion of a head of the end of the vessel that was removed to form a hole in which the nozzle is positionable.

11. The nozzle of claim 1, wherein the proximate side of the lip is spaced apart from an inner surface of the barrel defining the inner passageway at the first end of the nozzle by a distance that is between 2t and 6t such that a joint of the weld between the wall and the distal side of the lip is a distance of between 2t and 6t from the inner surface of the barrel defining the inner passageway at the first end of the nozzle.

12. The nozzle of claim 1, wherein the first distance is at least 2.5 cm.

13. The nozzle of claim 1, wherein the wall of the vessel is a wall of a vessel head having a thickness of at least 2.5 cm.

14. A vessel for an apparatus configured to utilize cyclic pressurization, the vessel comprising:
a body having a first end and a second end, the first end having an opening defined therein, the first end having a wall, the body of the vessel defining a chamber within the vessel;
a first nozzle positioned within the opening defined in the first end of the body, the first nozzle including:
a barrel attached to an annular lip, the barrel defining an inner passageway that is in fluid communication with a vessel interface opening defined by the lip at a first end of the first nozzle, a second end of the first nozzle opposite the first end of the first nozzle having an interface opening in communication with the inner passageway;
the lip having a distal side that is opposite a proximate side, the proximate side being positionable around an inner end of the barrel to define the vessel interface opening; and
the proximate side of the lip being spaced apart from the distal side of the lip by a first distance that is between 4 times a thickness of the wall (t) and 0.75t such that a joint of a weld between the wall and the distal side of the lip is a distance of between 4t and 0.75t from the proximate side of the lip.

15. The vessel of claim 14, wherein the second end of the body has an opening defined therein, the second end having a wall, the vessel also comprising:
a second nozzle positioned within the opening defined in the second end of the body, the second nozzle including:
a barrel attached to an annular lip, the barrel of the second nozzle defining an inner passageway that is in fluid communication with a vessel interface opening defined by the lip of the second nozzle at a first end of the second nozzle, a second end of the second nozzle opposite the first end of the second nozzle having an interface opening in communication with the inner passageway of the barrel of the second nozzle;
the lip of the second nozzle having a distal side that is opposite a proximate side, the proximate side of the lip of the second nozzle being positionable around an inner end of the barrel of the second nozzle to define the vessel interface opening of the second nozzle; and
the proximate side of the lip of the second nozzle being spaced apart from the distal side of the lip of the second nozzle by a distance that is between 4 times a thickness of the wall of the second end (t′) and 0.75t′ such that a joint of a weld between the wall of the second end and the distal side of the lip of the second nozzle is a distance of between 4t′ and 0.75t′ from the proximate side of the lip of the second nozzle.

16. The vessel of claim 14, wherein the first nozzle has an inner curved transition that is positioned to extend between the proximate side of the lip and the inner passageway of the barrel, the inner curved transition extending a distance of between 0.5t and 2t.

17. The vessel of claim 16, wherein the first nozzle has an outer curved transition that is positioned to extend between the proximate side of the lip and the barrel, the outer curved transition extending a distance that is between 0.5t and 3t.

18. The vessel of claim 17, wherein an annular wall of the barrel that defines the inner passageway has a thickness at an intermediate portion of the barrel that is located between the vessel interface opening and the interface opening of the second end of the first nozzle, the thickness at the intermediate portion of the barrel being between 0.5t and 3t.

19. The vessel of claim 18, wherein an outer surface of the barrel extends from the outer curved transition to the intermediate portion of the barrel is a distance that is between 0.5t and 6t.

20. The vessel of claim 19, wherein the barrel tapers from the intermediate portion to the interface opening of the second end of the first nozzle.

21. The vessel of claim 14, wherein the proximate side of the lip is spaced apart from an inner surface of the barrel defining the inner passageway at the first end of the first nozzle by a distance that is between 2t and 6t such that a joint of the weld between the wall and the distal side of the lip is a distance of between 2t and 6t from the inner surface of the barrel defining the inner passageway at the first end of the first nozzle.

22. The vessel of claim 14, wherein the apparatus configured to utilize cyclic pressurization is a pressure swing adsorption (PSA) system, a PSA system utilized for carbon dioxide capture, or is a buffer tank.

23. The vessel of claim 14, wherein the vessel has a diameter of at least 1.2 meters.

24. A process for providing at least one vessel, comprising:
forming a body of a vessel having a first head end, the body of the vessel defining a chamber;
cutting away a portion of an apex of a first end of the body of the vessel;
attaching a first nozzle to the first end of the body within a hole of the first end of the body formed via the cutting away of the portion of the apex of the first end of the body via welding that forms a weld joint between a distal side of an annular lip of the first nozzle and a wall of the first end of the body of the vessel, the wall of the first end of the body of the vessel having a thickness (t);
wherein the first nozzle is attached to the first end of the body such that a barrel defining an inner passageway that is attached to the lip of the first nozzle is in fluid communication with a vessel interface opening defined by the lip at a first end of the first nozzle, a second end of the first nozzle opposite the first end of the first nozzle having an interface opening in communication with the inner passageway;
the distal side of the lip being opposite a proximate side of the lip, the proximate side being positioned around an inner end of the barrel to define the vessel interface opening; and
the proximate side of the lip being spaced apart from the distal side of the lip by a first distance that is between 4 times a thickness of the wall (t) and 0.75t such that a joint of a weld between the wall and the distal side of the lip is a distance of between 4t and 0.75t from the proximate side of the lip.

25. The process of claim 24, wherein the first nozzle is a forged such that the lip and the barrel are integral to each other and the first nozzle does not include an inner projection.

26. The process of claim 24, wherein the proximate side of the lip being spaced apart from an inner surface of the barrel defining the inner passageway at the first end of the first nozzle by a distance that is between 2t and 6t such that the weld joint is a distance of between 2t and 6t from the inner surface of the barrel defining the inner passageway at the first end of the first nozzle.

27. A system for purification of a fluid comprising:
at least one vessel, each of the at least one vessel having:
a body having a first end and a second end, the first end having an opening defined therein, the first end having a wall, the body of the vessel defining a chamber within the vessel, at least one layer of adsorbent material being positioned within the chamber;
a first nozzle positioned within the opening defined in the first end of the body, the first nozzle including:
a barrel attached to an annular lip, the barrel defining an inner passageway that is in fluid communication with a vessel interface opening defined by the lip at a first end of the first nozzle, a second end of the first nozzle opposite the first end of the first nozzle having an interface opening in communication with the inner passageway;
the lip having a distal side that is opposite a proximate side, the proximate side being positionable around an inner end of the barrel to define the vessel interface opening;
the proximate side of the lip being spaced apart from the distal side of the lip by a first distance that is between 4 times a thickness of the wall (t) and 0.75t such that a joint of a weld between the wall and the distal side of the lip is a distance of between 4t and 0.75t from the proximate side of the lip.

28. The system of claim 27, wherein the at least one vessel includes a plurality of vessels and the system is configured as a pressure swing adsorption system.
